(19) United States
(12) Patent Application Publication
(10) Pub. No.: US 2008/0160253 A1
(43) Pub. Date: Jul. 3, 2008

(54) PLASTIC COATED EDGE STRUCTURE USED FOR PORTABLE ELECTRONIC DEVICE AND METHOD FOR MAKING THE SAME

(75) Inventors: WEN-QUAN LIU, Shenzhen (CN); WEI-JIE FAN, Shenzhen (CN); XI HE, Shenzhen (CN); LIAO-HUA FU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (TW); HON HAI PRECISION INDUSTRY CO., LTD., Tu-Cheng (TW)

(21) Appl. No.: 11/845,098

(22) Filed: Aug. 27, 2007

(30) Foreign Application Priority Data
Dec. 29, 2006 (CN) 200610201469.7

(51) Int. Cl. B32B 3/10; B29C 45/14

(52) U.S. Cl. 428/138; 264/328.1

(57) ABSTRACT

An exemplary plastic coated edge structure (10) includes a base sheet (11) and a protective plastic layer (12). A fringe portion of the base sheet defines a plurality of through holes (15). The protective plastic layer coats the fringe portion, and part of the protective plastic layer engages in the through holes. A method for making a plastic coated edge structure includes: providing a base sheet including a fringe portion, the fringe portion defining a plurality of though holes; putting the base sheet into an injection mold; injecting a melted plastic material into the injection mold from a side of the fringe portion to an opposite side of the fringe portion from the through holes to form the protective plastic layer for coating the fringe portion; solidifying the plastic material to form a plastic coated edge structure; and taking the plastic coated edge structure out of the injection mold.

### BACKGROUND OF THE INVENTION

1. Field of the Invention

The present invention generally relates to plastic coated edge structures and methods for making the same, and more particularly, to a plastic coated edge structure used for a portable electronic device.

2. Discussion of the Related Art

Presently, portable electronic devices such as mobile phones and personal digital assistants (PDAs) generally include a plurality of metallic components that includes metallic sheets. The metallic sheets are generally very thin. A plastic layer is applied to coat a fringe portion of the metallic sheet so as to form a plastic coated edge structure. The plastic coated edge structure has a high physical strength and can further prevent the fringe portion of the metallic sheet from damages and/or causing injuries.

Typically, a method for forming the plastic coated edge structure, a melted plastic material is injected from an exterior side of the metallic sheet to an opposite inner side of the metallic sheet to form the plastic layer at the two sides of the fringe of the metallic sheet. However, the melted plastic material is prone to solidify quickly and an injection path from the exterior side of the fringe portion of the metallic sheet to the opposite inner side of the fringe portion of the metallic sheet is relatively long, and if the plastic layer is very thin, the plastic material will not adequately coat the fringe portion of the metallic sheet. In addition, because the plastic layer for coating the fringe of the metallic sheet is thin, the plastic layer cannot engage with the fringe portion firmly and may be easy to disengage from the metallic sheet.

Therefore, a new plastic coated edge structure is desired in order to overcome the above-described shortcomings. A method for making such plastic coated edge structure is also desired.

### SUMMARY

In one aspect, a plastic coated edge structure used for a portable electronic device includes a base sheet and at least one protective plastic layer. At least one fringe portion of the base sheet defines a plurality of through holes. The at least protective plastic layer coats the at least fringe portion of the base sheet, and part of the protective plastic layer engages in the through holes.

In another aspect, a method for making the plastic coated edge structure includes: providing a base sheet including a fringe portion, and the fringe portion defining a plurality of though holes; putting the base sheet into an injection mold; injecting a melted plastic material into the injection mold from a side of the fringe portion of the base sheet to an opposite side of the fringe portion of the base sheet from the through holes to form a protective plastic layer for coating the fringe portion of the base sheet; solidifying the plastic material to form the plastic coated edge structure; and taking the plastic coated edge structure out of the injection mold.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present plastic coated edge structure (and method). Moreover, in the drawings, like reference numerals designate corresponding parts throughout the several views, and all the views are schematic.

FIG. 1 is an isometric view of a plastic coated edge structure in accordance with a first preferred embodiment of the present invention.

FIG. 2 is a cross-sectional view of the plastic coated edge structure shown in FIG. 1.

FIG. 3 is an isometric view of a base sheet of the plastic coated edge structure shown in FIG. 1.

FIG. 4 is an isometric view of a plastic coated edge structure in accordance with a second preferred embodiment of the present invention.

FIG. 5 is a cross-sectional view of the plastic coated edge structure shown in FIG. 4.

FIG. 6 is an isometric view of a base sheet of the plastic coated edge structure shown in FIG. 4.

FIG. 7 is an isometric view of a plastic coated edge structure in accordance with a third preferred embodiment of the present invention.

FIG. 8 is a cross-sectional view of the plastic coated edge structure shown in FIG. 7.

FIG. 9 is an isometric view of a base sheet of the plastic coated edge structure shown in FIG. 7.

FIG. 10 a cross-sectional view of an injection mold for making a plastic coated edge structure.

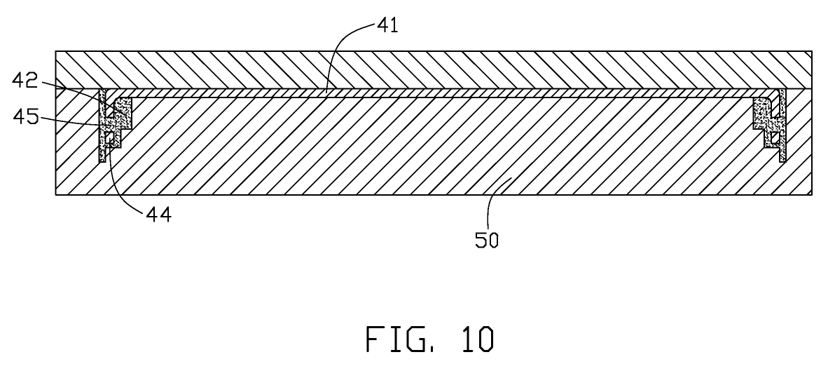

### DETAILED DESCRIPTION OF THE EMBODIMENTS

Reference will now be made to the drawings to describe preferred embodiments of the present plastic coated edge structure in detail.

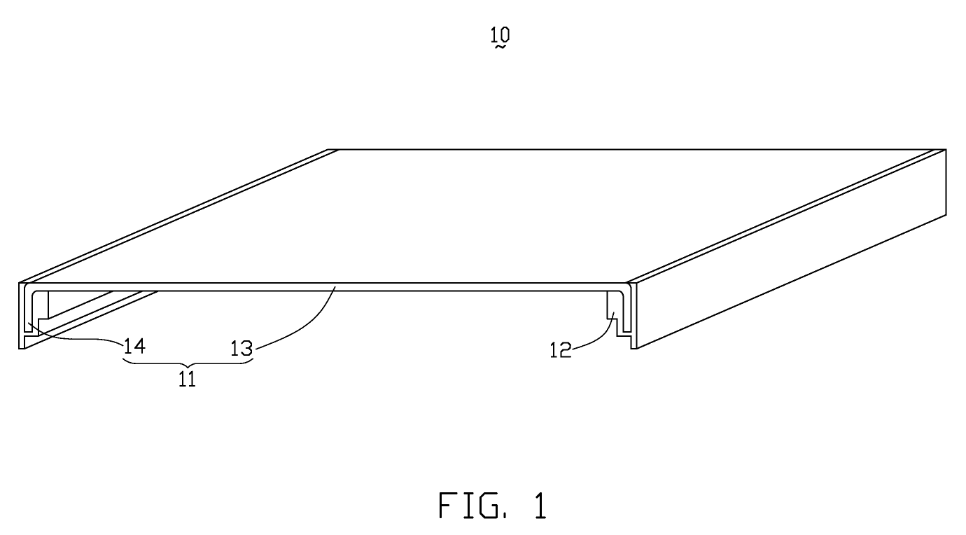

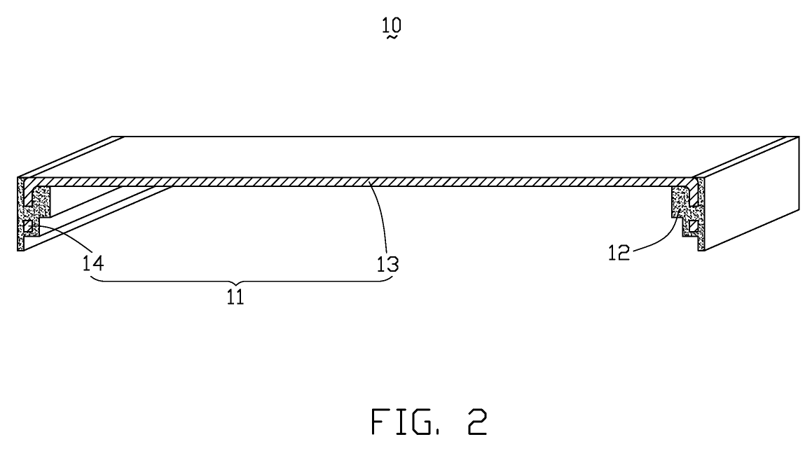

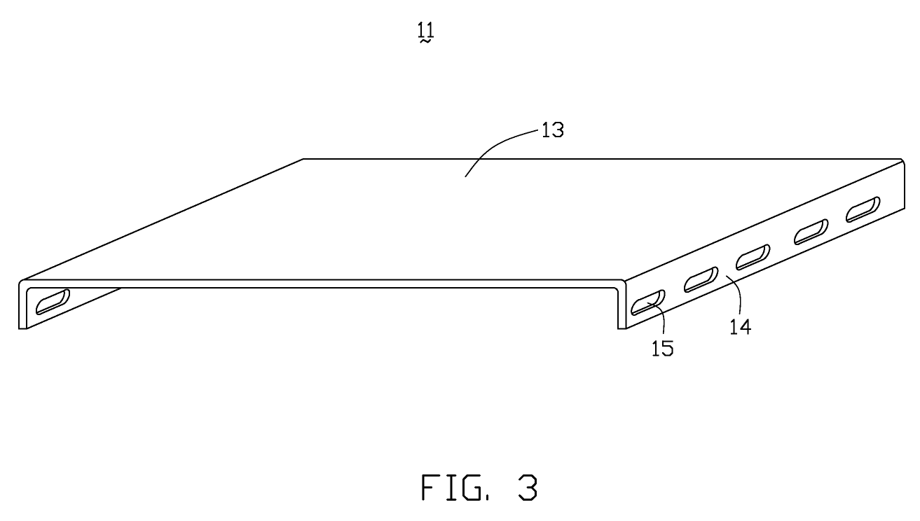

Referring to FIGS. 1 through 3, a plastic coated edge structure 10 used for portable electronic devices such as mobile phones and personal digital assistants (PDAs) in accordance with a first preferred embodiment is shown. The plastic coated edge structure 10 includes a base sheet 11 and at least one protective plastic layer 12 that coats a part of the base sheet 11. The base sheet 11 includes a main body 13 and at least one fringe portion 14. In this embodiment, the fringe portion 14 includes two sidewalls perpendicularly extending from opposite sides of the main body 13 correspondingly. The sidewalls are coated with the protective layer 12. Each of the sidewalls defines a plurality of through holes 15, and a part of the protective plastic layer 12 engages in the through holes 15. The through holes 15 are oblong circular holes and are defined along a middle of each sidewall and parallely aligned to each of the sidewalls. The base sheet 11 is made of metallic materials and the protective plastic layer 12 is made of plastic materials.

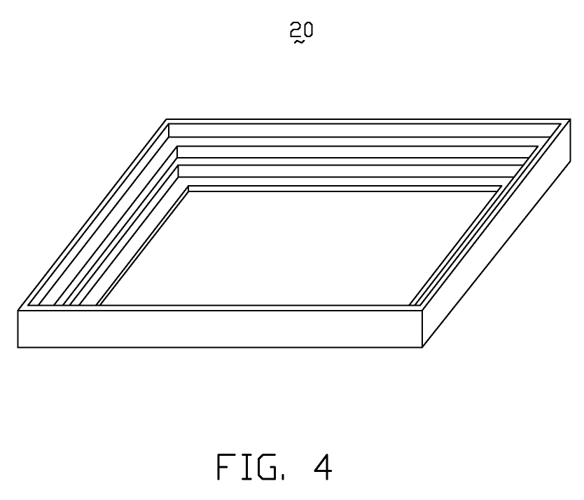

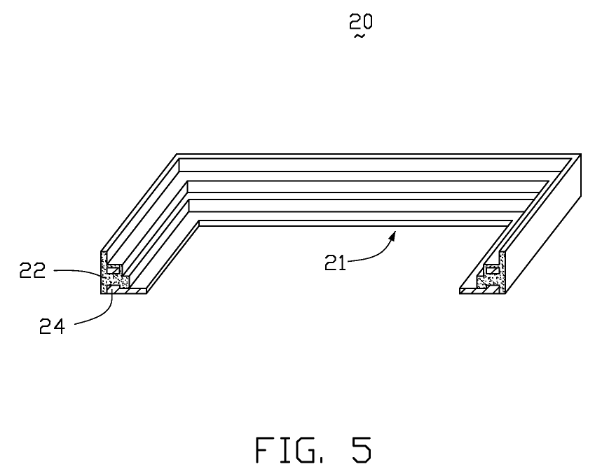

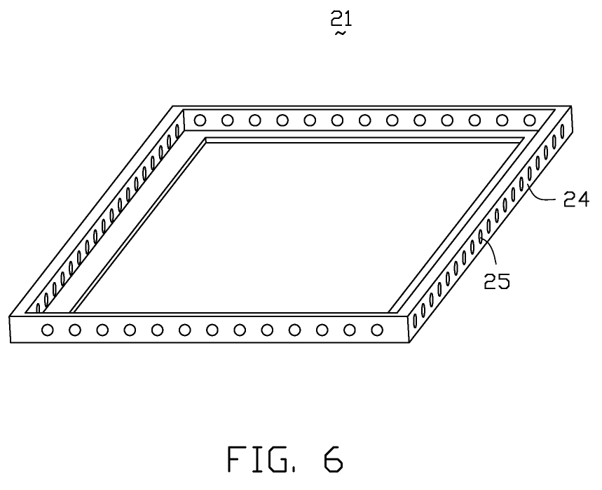

Referring to FIGS. 4 through 6, a plastic coated edge structure 20 in accordance with a second preferred embodiment is shown. The plastic coated edge structure 20 is similar in principle to the plastic coated edge structure 10 described above. The plastic coated edge structure 20 includes a base sheet 21 and at least one protective plastic layer 22 that coats a part of the base sheet 21. The base sheet 21 includes at least one fringe portion 24. In this embodiment, the fringe portion 24 includes four connecting sidewalls that correspondingly extending around the base sheet 21. The four sidewalls are coated with the protective layer 22. Each of the sidewalls defines a plurality of through holes 25 and a part of the protective plastic layer 22 engages in the through holes 25. The through holes 25 are circular holes defined along a middle of each sidewall and parallely aligned to each of the sidewall. The base sheet 21 is made of metallic materials and the protective plastic layer 22 is made of plastic materials.

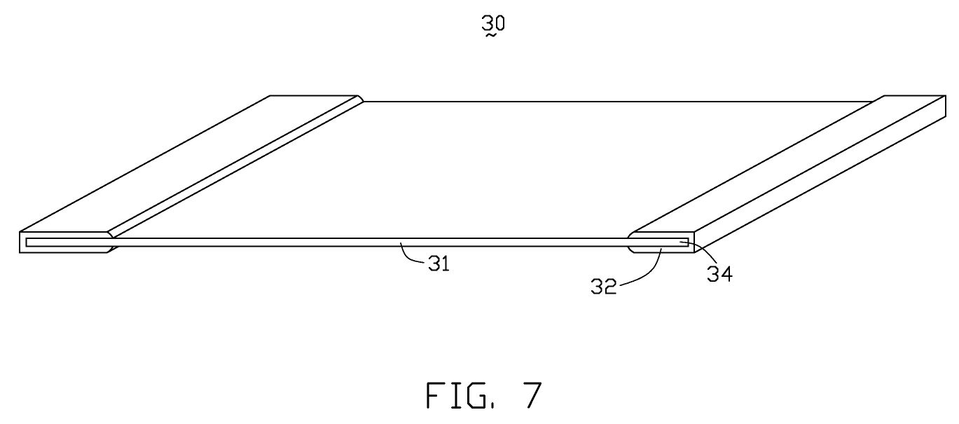

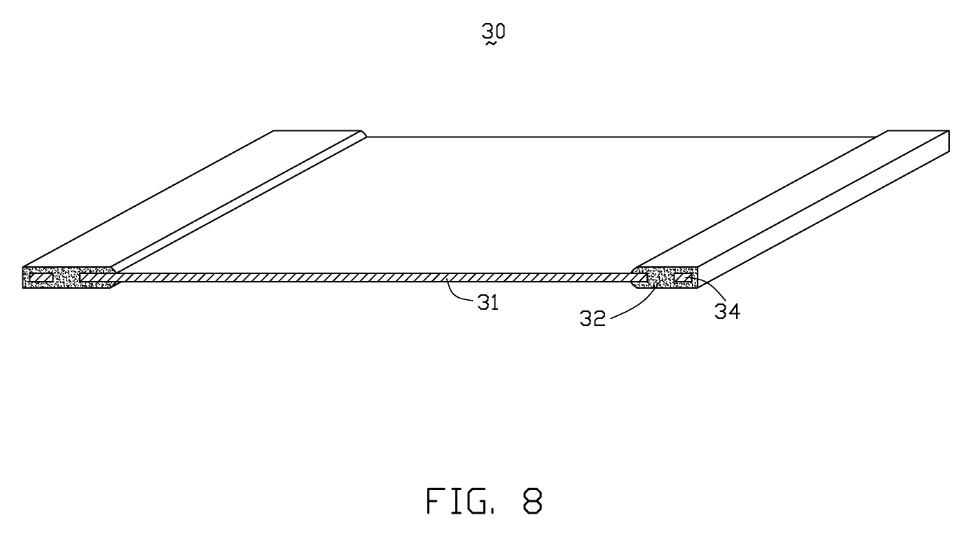

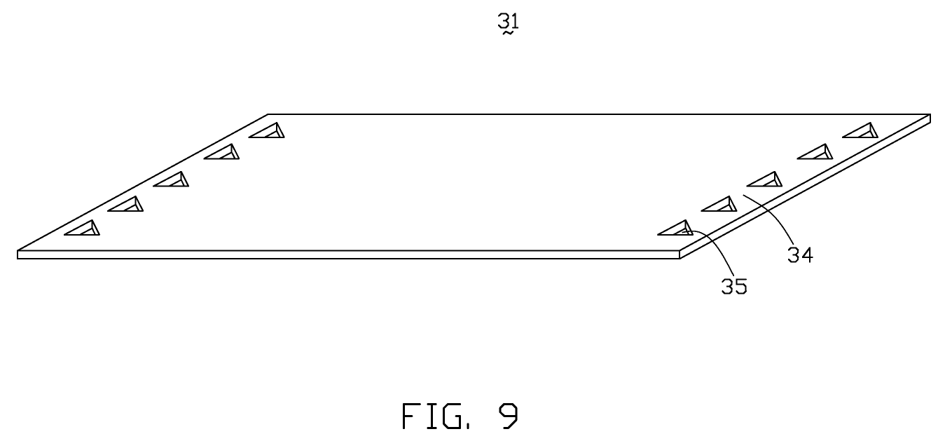

Referring to FIGS. 7 through 9, a plastic coated edge structure 30 in accordance with a third preferred embodiment is shown. The plastic coated edge structure 30 includes a base sheet 31 and at least one protective plastic layer 32 that coats at least one fringe portion 34 of the base sheet 31. The base sheet 31 is a plane sheet and the fringe portion 34 is a part of the base sheet 31. The fringe portion 34 defines a plurality of through holes 35 and a part of the protective plastic layer 32 engages in the through holes 35. In this embodiment, the through holes 35 are triangular holes and parallely aligned to the fringe portion 34. The base sheet 31 is made of metallic materials and the protective plastic layer 32 is made of plastic materials.

The protective plastic layers 12, 22, 32 partly engages in the through holes 15, 25, 35 correspondingly, thus the protective plastic layers 12, 22, 32 engages with the base sheets 11, 21, 31 firmly and is not easy to be disengaged from the metallic sheets 11, 21, 31.

An exemplary method for making a plastic coated edge structure will now be described. A base sheet 41 includes a fringe portion 44 is provided and the fringe portion 44 defines a plurality of though holes 45. The base sheet is put into an injection mold 50. A melted plastic material is injected into the injection mold 50 from one side of the fringe portion 44 of the base sheet 41 and the melted plastic material flows to the opposite side of the fringe portion 44 of the base sheet from the through holes to form a protective plastic layer 42 for coating the fringe portion 44. When the flow plastic material is solidified, the plastic coated edge structure (not labeled) is formed and is taken out of the injection mold 50.

As described above, the plastic material is injected from a side of the fringe portion of the base sheet to an opposite side of the fringe portion of the metallic sheet from the through holes, thus the plastic material can adequately coat the fringe portion of the base sheet.

In alternative embodiments, the base sheet can be made of other sturdy nonmetallic materials such as glass. The though holes can be of other shapes such as pentagon or hexagon. The though holes can also have different shapes from each other. The through holes are aligned in several rows parallel to the fringe of the base sheet.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A plastic coated edge structure used for a portable electronic device, comprising:
a base sheet including at least one fringe portion, the at least one fringe portion defining a plurality of through holes; and
at least one protective plastic layer for coating the at least one fringe portion of the base sheet, part of the at least one protective plastic layer engaging in the through holes.

2. The plastic coated edge structure as claimed in claim 1, wherein the base sheet comprises a main body and the fringe portion including at least one sidewall extending from one side of the main body, the through holes are defined on the sidewall and the sidewall is coated with the protective plastic layer.

3. The plastic coated edge structure as claimed in claim 2, wherein the though holes are parallely aligned to the sidewall.

4. The plastic coated edge structure as claimed in claim 1, wherein the fringe portion comprises at least three connecting sidewalls, and the through holes are defined on the sidewalls and the fringe portion is coated with the protective plastic layer.

5. The plastic coated edge structure as claimed in claim 1, wherein the though holes are circular holes.

6. The plastic coated edge structure as claimed in claim 1, wherein the though holes are oblong circular holes.

7. The plastic coated edge structure as claimed in claim 1, wherein the though holes are triangular holes.

8. The plastic coated edge structure as claimed in claim 1, wherein the base sheet is made of sturdy nonmetallic materials.

9. The plastic coated edge structure as claimed in claim 1, wherein the base sheet is made of metallic materials.

10. The plastic coated edge structure as claimed in claim 1, wherein the protective plastic layer is made of plastic materials.

11. A method for making a plastic coated edge structure, comprising:
providing a base sheet including a fringe portion and the fringe portion defining a plurality of though holes;
putting the base sheet into an injection mold;
injecting a melted plastic material into the injection mold from a side of a fringe portion of the base sheet to an opposite side of the fringe portion of the base sheet from the through holes to form a protective plastic layer for coating the fringe portion;
solidifying the plastic material to form the plastic coated edge structure; and
taking the plastic coated edge structure out of the injection mold.

12. The method as claimed in claim 11, wherein the though holes are circular holes.

13. The method as claimed in claim 11, wherein the though holes are oblong circular holes.

14. The method as claimed in claim 11, wherein the though holes are triangular holes.

15. The method as claimed in claim 11, wherein the base sheet is made of sturdy nonmetallic materials.

16. The method as claimed in claim 11, wherein the base sheet is made of metallic materials.
